(19) United States
(12) Patent Application Publication
(10) Pub. No.: US 2023/0312781 A1
(43) Pub. Date: Oct. 5, 2023

(54) ULTRA-HIGH MOLECULAR WEIGHT POLYETHYLENE POLYMERS HAVING IMPROVED PROCESSABILITY AND MORPOLOGY

(71) Applicant: SABIC GLOBAL TECHNOLOGIES B.V., BERGEN OP ZOOM (NL)

(72) Inventors: Enrico TROISI, Eindhoven (NL); Nicolaas Hendrika FRIEDERICHS, Brunssum (NL); Theo TERVOORT, Zurich (CH); Fotios CHRISTAKOPOULOS, Stanford, CA (US)

(21) Appl. No.: 18/022,587

(22) PCT Filed: Aug. 30, 2021
(86) PCT No.: PCT/EP2021/073840

§ 371 Date: Feb. 22, 2023

(30) Foreign Application Priority Data
Sep. 3, 2020 (EP) 20194393.3

(51) Int. Cl. C08F 110/02

(52) U.S. Cl. CPC C08F 110/02

(57) ABSTRACT

An ultra-high molecular weight polyethylene polymer has: a powder bulk density of at least 200 kg/m³; an intrinsic viscosity (I.V.) of at least 8 dl/g, as measured in accordance with ASTM D4020; and wherein, a specimen prepared from the ultra-high molecular weight polyethylene can be drawn in the absence of a solvent, at a total draw ratio of at least 50, when drawing at a drawing temperature of ≥Tₘ−30° C., wherein Tₘ is the melting temperature of the ultra-high molecular weight polyethylene polymer. A supported catalyst system for producing such UHMWPE polymers includes a transition metal complex and a particulate catalyst support including particles having a volume based median particle diameter of at least 0.3 micrometer. Articles derived from such polymers having excellent strength and modulus.

### CROSS REFERENCE TO RELATED APPLICATIONS

This application is a National Stage application of PCT/EP2021/073840, filed Aug. 30, 2021, which claims the benefit of European Application No. 20194393.3, filed Sep. 3, 2020, both of which are incorporated by reference in their entirety herein.

### BACKGROUND

The invention relates to the field of Ultra High Molecular Weight Polyethylene (UHMWPE) polymers having improved processability and powder morphology. In particular, the invention relates to UHMWPE polymers, which enable solid state drawing of polymer specimens at high draw ratio while imparting desired strength and modulus to articles.

A special class of polyolefins are the ultra-high molecular weight polyethylene (further referred to as UHMWPE), which have exceptionally high molecular weight compared to conventional polyethylene polymers. The high molecular weight attribute of UHMWPE polymers, imparts outstanding strength and modulus to articles produced from such polymers. However, owing to this very attribute of having high molecular weight, UHMWPE polymers demonstrate poor flowability, which in turn affects the processability of these polymers especially when using conventional processing techniques such as melt spinning or melt extrusion. The origin of poor processability can be traced back to the extensive polymer chain entanglements.

Conventional UHMWPE polymer due to its high polymer chain entanglement results in low draw ratio, which in turn adversely affects the strength and modulus of the produced articles as has been described in the in the publication, (Smith et.al) Journal of Materials Science, 1980 (15) page 505-514. In fact, the published document, Journal of Materials Science 1987 (22) page 523-531, describes that conventional UHMWPE polymer cannot be drawn in solid state at high draw ratios (draw ratio >10) due to polymer chain entanglement. Therefore, lowering the polymer chain entanglement is recognized as a key consideration in improving the processability of UHMWPE polymers. In the past, processability of UHMWPE polymers have been improved through the use of the solution spinning process, which induces the lowering of polymer entanglement density, when such polymers are dissolved in a solvent. However, solution spinning requires lot of organic solvent to effect the process, which adds to operational complexities such as solvent recycling and recovery and disposing of such solvent.

Another important parameter to evaluate UHMWPE polymer, is its powder bulk density, which indicates the quality of the powder morphology. As described in the published application WO2009112254, bulk density for UHMWPE polymer, should be high in order to ensure effective polymer processing as well as for ensuring efficient storage and transportation of the polymers. Therefore, there has been a requirement from both industry and academia for a UHMWPE polymer, which has high bulk density and which can be drawn in its solid state at high draw ratio while imparting the desired mechanical property of strength (breaking tenacity) and modulus to articles produced from such polymers.

Disentangled UHMWPE polymers (d-UHMWPE) is a class of UHMWPE polymer which can be drawn at solid state and offers another possible solution for improving the processability of UHMWPE polymer. Disentangled UHMWPE polymers are distinct from low entangled UHMWPE polymers, previously reported in the publication Macromolecules 2011, 44, 14, pp. 5558-5568 (“Macromolecules 2011”). Compared to low entangled UHMWPE polymers, disentangled UHMWPE polymers can be drawn in solid state over a wider range of drawing temperatures and provide higher breaking tenacity for a given draw ratio. However, compared to low entangled UHMWPE polymers, disentangled UHMWPE polymers tend to have undesirable bulk density. In particular, this difference between disentangled UHMWPE polymers and low entangled UHMWPE polymers is clear from the results shown in Macromolecules 2011, where disentangled UHMWPE polymers demonstrate higher strength compared to low entangled UHMWPE polymers, but suffer from poor bulk density.

The published patent application WO87/03288 (Smith et.al) describes a UHMWPE polymer which may be drawn in solid state i.e drawn at a temperature below the melting temperature of the polymer. As described in the patent WO87/03288, disentangled UHMWPE polymers can be directly used for producing high strength and high modulus films and fibers, without the need for elaborate processing steps involving spinning, casting, dissolution, and drying. However, the UHMWPE polymer described in the patent WO87/03288 describes properties, which are indicative of poor powder morphology and therefore unsuitable for industrial production. Although the invention described in WO87/03288 targets the improvement of draw ratios in UHMWPE polymer, the draw ratios demonstrated in the patent can still be further improved upon, for example above 50 for further improving strength and modulus. Further, the catalyst system described in the patent publication WO87/03288, is prone to induce reactor fouling, which would result in unplanned reactor shut downs and reduced productivity.

Although other published literature such as the published patent applications WO2013076733, WO2013/118140, US2012095168 or the published article Macromolecules 2011 provide useful understanding in developing disentangled and/or low entangled UHMWPE polymers, the polymers described in these publications, suffer from low powder bulk density and irregular powder shape, indicative of poor powder morphology. On the other hand, the published patent application WO93/15118 describes the production of ethylene polymer with a bulk density of at most 300 kg/m³ having a draw ratio of at least 20. However, the patent describes by way of examples, polymers having a relatively moderate draw ratio, which although promising, can be further improved upon. Further, the polymers described in the application WO93/15118 are produced using Zeigler Natta catalysts, which typically results in low entangled UHMWPE polymers and do not impart the desired strength and modulus to produced articles.

Accordingly, there remains a need for developing UHMWPE polymer having one more benefits of (i) having high bulk density, (ii) imparting solid state drawing in the absence of solvent at high draw ratio, and (iii) imparting the desired strength and modulus to articles prepared from such UHMWPE polymers.

### SUMMARY

Accordingly, one of the objectives of the present invention includes providing a ultra-high molecular weight polyethylene (UHMWPE) polymer having one more benefits of (i) having high bulk density, (ii) imparting solid state drawing in the absence of solvent at high draw ratio, and (iii) imparting the desired strength and modulus to articles prepared from such UHMWPE polymers. It is another objective of the invention to provide a catalyst system suitable for the production of disentangled UHMWPE polymers having the desired powder morphology without causing reactor fouling. Yet another objective of the present invention is to prepare articles such as tapes, fibers and filaments having high strength and modulus.

The objective of the present invention is achieved by providing an ultra-high molecular weight polyethylene polymer having:
a powder bulk density of at least 200 kg/m³, preferably at least 300 kg/m^{3,} as measured in accordance with ASTM D1895/A (1996, reapproved 2010-e1);
an intrinsic viscosity (I.V.) of at least 8.0 dl/g, preferably at least 10.0 dl/g, as measured in accordance with ASTM D4020 (2005); and
   wherein a specimen prepared from the ultra-high molecular weight polyethylene can be drawn in the absence of a solvent, at a total draw ratio of at least 50.0, preferably at least 90.0, when drawing at a drawing temperature of ≥Tₘ−30° C., wherein Tₘ is the melting temperature of the ultra-high molecular weight polyethylene polymer.

### BRIEF DESCRIPTION OF THE DRAWINGS

For a more complete understanding, reference is now made to the following descriptions taken in conjunction with the accompanying drawings, in which:

FIG. 1 is a graphical representation of Breaking Tenacity of tapes prepared under Examples 1-4 and drawn at various draw ratios;

FIG. 2 is a Scanning Electron Microcopy (SEM) image of polymer powder prepared under inventive Example 1 (Sample Code: 20190925AOK2);

FIG. 3 is a SEM image of polymer powder prepared under comparative Example 3 (Sample Code: 20191127AKO2); and

FIG. 4 is a SEM image of polymer powder prepared under comparative Example 4 (Sample Code: ACE-170922-uh1).

### DETAILED DESCRIPTION

In some aspects of the invention, the powder bulk density of the ultra-high molecular weight polyethylene polymer ranges from 200 kg/m³ to 700 kg/m³, preferably 250 kg/m³ to 650 kg/m^{3.} preferably 300 kg/m³ to 450 kg/m³. For the purpose of the present invention, the powder bulk density of the ultra-high molecular weight polyethylene polymer can be measured in accordance with the procedure outlined in ASTM D1895/A. In certain instances, the powder bulk density of the ultra-high molecular weight polyethylene polymer is measured in accordance with the procedure outlined in ASTM D1895/A with a modification involving the piercing of the ultra-high molecular weight polyethylene polymer with a spatula to promote polymer flow. As may be appreciated by a person skilled in the art, the UHMWPE polymer of the present invention demonstrates excellent powder morphology indicated by its high bulk density over existing disentangled UHMWPE polymers, known in the art. The high bulk density of the UHMWPE polymers ensures ease of processability especially if the polymer processing involves powder sintering and ensures ease of handling and storage of the polymer powders.

In some aspects of the invention, the intrinsic viscosity (I.V.) ranges from 8.0 dl/g to 100.0 dl/g, preferably ranging from 10.0 dl/g to 70.0 dl/g, preferably ranging from 20.0 dl/g to 65.0 dl/g, as measured in accordance with ASTM D4020. From the intrinsic viscosity data, it may be concluded that the polyethylene polymer is a high molecular weight polyethylene. This viscosity value can subsequently be translated to the molecular weight value using the Mark Houwink equation. In some aspects of the invention, the viscosity average molecular weight (Mv) of the UHMWPE polymer is higher than 500000 g/mol, preferably above 750000 g/mol, and more preferably above 1000000 g/mol.

In some aspects of the invention, the specimen prepared from the ultra-high molecular weight polyethylene can be drawn in the absence of a solvent at a total draw ratio ranging from 50.0 to 300.0, preferably 60.0 to 250.0, preferably ranging from 65.0 to 230.0, when drawing, at a drawing temperature of ≥Tₘ−30° C., wherein Tₘ is the melting temperature of the ultra-high molecular weight polyethylene polymer. As may be appreciated by a person skilled in the art, the ability to draw a specimen prepared from the UHMWPE polymer at temperatures below its melting allows is referred to as solid state drawing and represents a characteristic property of the polymer. The expression “specimen” as used in this disclosure means a calendared or a compression molded or a rolled film or a tape or a fiber, which is obtained from the inventive UHMWPE polymer powder after compacting the polymer powder, such that the specimen can be subsequently drawn in solid state.

In some embodiments of the invention, the ultra-high molecular weight polyethylene polymer is drawn at drawing temperature of ≥Tₘ−30° C., preferably ≥Tₘ−15° C., preferably ≥Tₘ−10° C., preferably ≥Tₘ−5° C. In some embodiments of the invention, the ultra-high molecular weight polyethylene polymer is drawn at any drawing temperature between ≥Tₘ−30° C. and Tₘ, preferably at any temperature between ≥Tₘ−15° C. and Tₘ, preferably at any temperature between ≥Tₘ−10° C. and Tₘ, preferably at any temperature between ≥Tₘ−5° C. and Tₘ. The melting temperature of the polymer can be determined by using Differential Scanning calorimeter (DSC) as described under Example 1 in the present disclosure. The ability to draw a specimen prepared from the UHMWPE polymer at such wide range of drawing temperature and at high draw ratios, provides a wide processing window for manufacturing fibers, tapes, and filaments.

In some aspects of the invention the UHMWPE polymer is a disentangled UHMWPE polymer. The expression “disentangled UHMWPE polymer” as used in this invention means a polymer which when used for preparing a specimen, enables the specimen to be drawn in solid state in the absence of a solvent, at draw ratios greater than 50 and at a drawing temperature as low as ≥Tₘ−30° C. Typically, when the drawing temperature is used as low ≥Tₘ−30° C., articles such as fibers and filaments can be made having high strength and modulus without the need for elaborate steps involving solution spinning, casting techniques, dissolution, precipitation, extraction and drying. The expression “drawing in the absence of a solvent” as used herein means that the drawing of the specimen is carried out in solid state without the need of using solution or gel spinning technique or using solution crystallization. For the purpose of solid state drawing as described in the present invention, the UHMWPE polymer powders may be compacted and processed in solid state for the purpose of drawing.

In some embodiments of the invention, the UHMWPE polymer powder has suitable particle size indicating improved particle morphology. In some aspects of the invention, the ultra-high molecular weight polyethylene polymer is an ultra-high molecular weight polyethylene polymer powder having an average particle size (D₅₀) in the range of 50.0 to 250.0 micrometer, preferably in the range between 60.0 to 200.0 micrometer, as measured in accordance with ISO-13320 (2009). The average particle size (D₅₀) of the catalyst can be determined by using the laser light scattering method involving hexane diluent and using a Malvern Mastersizer equipment.

In some aspects of the invention, the ultra-high molecular weight polyethylene polymer is a copolymer comprising:
at least 95.0 wt. %, preferably at least 98.0%, preferably at least 99.0 wt. %, preferably at least 99.9 wt. %, with regard to the total weight of the ultra-high molecular weight polyethylene polymer, of moieties derived from ethylene; and
at most 5.0 wt. %, preferably at most 2.0 wt. %, preferably at most 1.0 wt. %, preferably at most 0.1 wt. %, with regard to the total weight of the ultra-high molecular weight polyethylene polymer, of moieties derived from one or more a-olefins selected from propylene, 1-butene, 4-methyl-1-pentene, 1-hexene, and 1-octene, preferably selected from propylene, 1-butene,1-hexene and 1-octene.

In some embodiments of the invention, the ultra-high molecular weight polyethylene polymer is a copolymer comprising 95.0 wt. % to 100 wt. % with regard to the total weight of the ultra-high molecular weight polyethylene polymer, of moieties derived from ethylene. In some embodiments of the invention, the ultra-high molecular weight polyethylene polymer is a copolymer comprising 0.1 wt. % to 5.0 wt. % with regard to the total weight of the ultra-high molecular weight polyethylene polymer, of moieties derived from one or more α-olefins.

In some aspects of the invention, the invention relates to a discrete transition-metal complex on a particulate solid support material for producing ultra-high molecular weight polyethylene polymer. In some aspects of the invention, the invention relates to a catalyst composition for preparing the ultra-high molecular weight polyethylene polymer of the present invention, comprising:
a. a transition metal complex represented by a formula (I) LₙMX₍ₖ₋ₙ₎, wherein
   L represents an organic ligand,
   M represents a transition metal,
   X represents a substituent selected from fluorine, chlorine, bromine or iodine, an alkyl group having 1-20 carbon atoms, an aralkyl group having 1-20 carbon atoms, a dialkylamine group having 1-20 carbon atoms or an alkoxy group having 1-20 carbon atoms,
   k represents a positive integer and is the valency of the transition metal ‘M’,
   n is an integer defined by the relation 1≤n≤k; and
b. a particulate catalyst support, comprising particles having a volume based median particle diameter of at least 0.3 micrometer, preferably at least 1.0 micrometer, wherein the transition metal complex is supported on the particulate catalyst support.

In some aspects of the invention, the invention relates to an ultra high molecular weight polyethylene, having:
a powder bulk density of at least 200 kg/m³; preferably at least 300 kg/m³;
an intrinsic viscosity (I.V.) of at least 8.0 dl/g, preferably at least 10.0 dl/g, as measured in accordance with ASTM D4020; and
   wherein, a specimen prepared from the ultra-high molecular weight polyethylene can be drawn in the absence of a solvent, at a total draw ratio of at least 50.0, preferably at least 90.0, when drawing at a drawing temperature of ≥Tₘ−30° C., wherein Tₘ is the melting temperature of the ultra-high molecular weight polyethylene polymer;
   wherein the ultra-high molecular weight polyethylene is produced from a catalyst comprising:
a. a transition metal complex represented by a formula (I) LₙMX₍ₖ₋ₙ₎, wherein
   L represents an organic ligand,
   M represents a transition metal,
   X represents a substituent selected from fluorine, chlorine, bromine or iodine, an alkyl group having 1-20 carbon atoms, an aralkyl group having 1-20 carbon atoms, a dialkylamine group having 1-20 carbon atoms or an alkoxy group having 1-20 carbon atoms,
   k represents a positive integer and is the valency of the transition metal ‘M’,
   n is an integer defined by the relation 1≤n≤k; and
b. a particulate catalyst support, comprising particles having a volume based median particle diameter of at least 0.3 micrometer, preferably at least 1.0 micrometer, wherein the transition metal complex is supported on the particulate catalyst support.

In some aspects of the invention, the particulate catalyst support comprises particulate organo-aluminium selected from methyl-aluminoxane (MAO), iso-butyl-aluminoxane, methyl-isobutyl aluminoxane, ethyl-isobutyl-aluminoxane, preferably the particulate organo-aluminium is methyl-aluminoxane (MAO). In some embodiments of the invention, the particulate catalyst support comprises particles having a volume based median particle diameter ranging from 0.3 micrometer to 200.0 micrometer, preferably ranging from 1.0 micrometer to 100.0 micrometers, preferably ranging from 5.0 micrometers to 50.0 micrometers. The particle size of the support may be determined using laser diffraction/scattering method in a dry nitrogen atmosphere using a Mastersizer 2000 Hydro S from Malvern Instrument Ltd.

In some preferred aspects of the invention, the methyl-aluminoxane (MAO) is a morphology controlled solid methyl-aluminoxane (MAO), for example, as those described in the U.S. Pat. Nos. 8,404,880, 9,340,630 and in US2018/0355077 (assigned to Tosoh) or WO03/051934 (assigned to Borealis). The morphology controlled solid MAO includes suspension of solid methyl-aluminoxane (MAO) particles in a hydrocarbon diluent. The inventors of the present invention, found that when such morphology controlled solid MAO, was used as a catalyst support, the UHMWPE polymer so obtained had well defined morphology, which is in sharp contrast to soluble MAO (MAO dissolved in hydrocarbon solvent and typically used as co-catalyst and not as a catalyst support). This conclusion is also evidenced from the polymers obtained from inventive examples. Surprisingly, the inventors found that when a catalyst having morphology controlled solid MAO is used, the UHMWPE polymer so obtained is a disentangled UHMWPE polymer.

In some embodiments of the invention, the organic ligand (L) is selected from substituted or unsubstituted cyclopentadienyl, indenyl, fluorenyl, naphthyl, phenoxy, imine, amine, pyridyl, phenoxy-imine, phenoxy-amine, phenoxy-ether, quinolyl-indenyl, phenoxy-ether, benzyl, neophyl, neopentyl, or a combination thereof, preferably the organic ligand (L) is selected from phenoxy-imine, phenoxy-amine, and phenoxy-ether. In some embodiments of the invention, transition metal complexes are the ones that have an organic ligand (L) based on a cyclopentadienyl derivative connected to a pyridyl or quinolyl moiety, preferably a dichloro-1-(8-quinolyl-indenyl) chromium complex.

In some embodiments of the invention, the transition metal (M) is a metal selected from group IV of Mendelejev's Periodic Table of Elements, preferably the transition metal (M) is titanium. In some embodiments of the invention, the particulate catalyst support is organo-aluminium and the molar ratio of aluminum metal present in the particulate catalyst support to transition metal complex ranges from 50 to 5000, preferably ranges from 75 to 1000, preferably ranges from 100 to 800.

In some preferred embodiments of the invention, the catalyst composition comprises bis-phenoxy-imine titanium dichloride supported on particulate methyl-aluminoxane (MAO) particles having a volume based median particle diameter of at least 0.3 micrometer, preferably at least 1.0 micrometer, preferably at least 5.0 micrometer. The compound bis-phenoxy-imine titanium dichloride may be referred to as “Fl compound”. In some embodiments of the invention, the active catalyst component is formed by activating the Fl compound with the particulate methyl-aluminoxane (MAO). Without wishing to be bound by any specific theory, the methyl-aluminoxane (MAO) particles function as a catalyst support and a co-catalyst activator.

The improved performance of the methyl-aluminoxane (MAO) supported Fl compound catalyst in terms of the property of the produced polymer is particularly surprising, when compared with the performance of the nano particle supported Fl compound catalyst reported in the published patent WO2010/139720, where the small sized nano-particles are intended to limit interactions of catalyst active sites and thereby lower polymer entanglement. However, the mechanical strength and modulus of polymers described in WO2010/139720 is comparable to low entangled UHMWPE polymers, which is lower than the polymers obtained from the present invention.

In some embodiments of the invention, the catalyst composition further comprises a scavenger additive selected from an organolithium compound, an organo-magnesium compound, an organo-aluminum compound, an organo-zinc compound, and mixtures thereof. Non-limiting examples organo-aluminum compounds are trimethylaluminum, triethylaluminium, triisopropylaluminum, tri-n-propylaluminum, triisobutylaluminum, tri-n-butylaluminum, tri-tert-butylaluminium, isoprenylaluminium, triamylaluminium; tri-n-hexyl aluminium, tri-octyl-aluminium, dimethylaluminium ethoxide, diethylaluminium ethoxide, diisopropylaluminium ethoxide, di-n-propylaluminium ethoxide, diisobutylaluminium ethoxide and di-n-butylaluminium ethoxide, dimethylaluminium hydride, diethylaluminium hydride, diisopropylaluminium hydride, di-n-propylaluminium hydride, diisobutylaluminium hydride and di-n-butylaluminium hydride, soluble aluminoxanes, particulate aluminoxanes and mixtures thereof. Without wishing to be bound by any theory, the scavenger additive helps in scrubbing impurities from a polymerization system which would have otherwise adversely affected the catalyst performance. In some embodiments of the invention, organo-aluminum compounds may be combined with a compound containing at least one active hydrogen and which is capable of reacting with the organo-aluminum compounds. Non-limiting examples of such compounds having at least one active hydrogen includes alcohol compounds, silanol compounds and amine compounds. Suitable alcohol compounds include mono-phenolic compounds, for example butylated hydroxy toluene (BHT, 2,6-ditBu-4-methyl-phenol), 2,6-ditBu-phenol or α-tocoferol (vitamin-E). Non-limiting examples of amine compounds include cyclohexyl amine or an alkylamine.

The ultra-high molecular weight polyethylene polymer of the present invention can be produced using a gas phase process or a slurry process, as long as the polymer is formed as a particulate solid powder. The production processes of polyethylene are summarized in “Handbook of Polyethylene” by Andrew Peacock (2000; Dekker; ISBN 0824795466) at pages 43-66. The polymerization reaction may be performed in the gas phase or in bulk in the absence of an organic solvent, or carried out in liquid slurry in the presence of an organic diluent. The polymerization can be carried out in batch, semi-batch or in a continuous mode. In some aspects of the invention, the invention relates to a process for preparing the ultra-high molecular weight polyethylene polymer of the present invention comprising the step of polymerizing ethylene and optionally one or more α-olefins in the presence of a supported catalyst composition and optionally in presence of hydrogen.

In some aspects of the invention, the polymerization temperature ranges from 0° C. to 140° C., preferably ranges from 10° C. to 90° C., preferably ranges from 25° C. to 80° C. The pressure of a monomer during polymerization is adequately the atmospheric pressure and more preferably 1-50 bars. (1 bar=100000 Pa). In some aspects of the invention, after the polymerization, any residual reactive components from the catalyst or the scavenger present in the polymerization reactor, may be deactivated by adding the so-called “killing agents” in the polymerization vessel. Such killing agents are well known in the art and are chemical components that deactivate the catalyst and scavenger. Non-limiting examples of killing agents include oxygen, water, alcohols, stearates or amines.

In some aspects of the invention, the present invention is directed to an article prepared from the ultra-high molecular weight polyethylene of the present invention having:
a powder bulk density of at least 200 kg/m³; preferably at least 300 kg/m³;
an intrinsic viscosity (I.V.) of at least 8.0 dl/g, preferably at least 10.0 dl/g, as measured in accordance with ASTM D4020; and
   wherein a specimen prepared from the ultra-high molecular weight polyethylene can be drawn in the absence of a solvent, at a total draw ratio of at least 50.0, preferably at least 90.0, when drawing at a drawing temperature of ≥Tₘ−30° C., wherein Tₘ is the melting temperature of the ultra-high molecular weight polyethylene polymer.

In some embodiments of the invention, the article is a drawn article characterized in that the breaking tenacity of the drawn article is related to the total draw ratio (DR) used for preparing the drawn article in accordance with equation (I):

BT>α*ln(DR)−β (Eqn I)

wherein the total draw ratio (DR) is at least 50.0, and the breaking tenacity (BT) is expressed in N/tex and 0.835≤α≤0.881 and 1.787≤β≤1.887 and the ratio of α/β is 0.467.

In some preferred embodiments of the invention, the article is a drawn article characterized in that the breaking tenacity of the drawn article is related to the total draw ratio (DR) used for preparing the drawn article in accordance with equation (II):

BT>0.835*ln(DR)−1.787 (Eqn II)

From equation (I) and (II), it is evident that the articles prepared from the ultra-high molecular weight polyethylene polymer has high strength and can be prepared at high drawing ratios. In some aspects of the invention, the article has a tensile modulus ranging from 2.0 GPa to 9.0 GPa, ranging from 3.0 GPa to 8.0 GPa when determined in accordance with the procedure set forth under ASTM D7744/D7744M-11.

In some aspects of the invention, the invention is directed to a process for preparing the drawn article of the present invention, comprising the step of:
compacting the ultra-high molecular weight polyethylene polymer powder into a film specimen having a length of L₁;
rolling and/or calendaring the film specimen to a rolled film specimen having a length of L₂ at a drawing ratio represented by the ratio L₂/L₁≥2; and
drawing the rolled film specimen at a drawing temperature of ≥Tₘ−30° C. and forming the drawn article having a length of L₃, wherein Tₘ is the melting temperature of the ultra-high molecular weight polyethylene polymer and wherein the rolled film specimen is drawn at a drawing ratio represented by the ratio L₃/L₂, such that the total draw ratio L₃/L₁≥50.

The total draw ratio (L₃/L₁) is determined as the product of L₂/L₁×L₃/L₂. For determining each of L₂/L₁ and L₃/L₂, the cross section of the drawn article obtained in each step may be determined using optical microscopy. The cross section may be determined using the concept of conservation of volume using the equation Lₙ=wₙ*tₙ, where ‘Lₙ’ is the length of the specimen, ‘wₙ’ is the width and ‘tₙ’ is the thickness of the specimen, where ‘n’ can be 1, 2 or 3.

The compaction may for example be performed at a temperature of between Tₘ−30° C. and Tₘ, preferably between Tₘ−15° C. and Tₘ. The compaction may for example be performed at a pressure of >100 bar and <300 bar, preferably of >150 bar and <250 bar. The rolling may for example be performed to a ratio L₂/L₁ of between 2 and 5, preferably of between 3 and 4. The rolling may for example be performed at a temperature of between Tₘ−30° C. and Tₘ, preferably between Tₘ−15° C. and Tₘ. Preferably, the temperature during rolling is below the temperature during compaction.

In some aspects of the invention, the invention relates to an ultra high molecular weight polyethylene, having:
a powder bulk density of at least 200 kg/m³; preferably at least 300 kg/m³;
an intrinsic viscosity (I.V.) of at least 8 dl/g, preferably at least 10 dl/g, as measured in accordance with ASTM D4020; and
   wherein a specimen prepared from the ultra-high molecular weight polyethylene can be drawn in the absence of a solvent, at a total draw ratio of at least 50.0, preferably at least 90.0, when drawing at a drawing temperature of ≥Tₘ−30° C., wherein Tₘ is the melting temperature of the ultra-high molecular weight polyethylene polymer;
   wherein, the ultra-high molecular weight polyethylene is produced from a catalyst comprising:
a. a transition metal complex represented by a formula (I) LₙMX₍ₖ₋ₙ₎, wherein,
   L represents an organic ligand,
   M represents a transition metal,
   X represents a substituent selected from fluorine, chlorine, bromine or iodine, an alkyl group having 1-20 carbon atoms, an aralkyl group having 1-20 carbon atoms, a dialkylamine group having 1-20 carbon atoms or an alkoxy group having 1-20 carbon atoms,
   k represents a positive integer and is the valency of the transition metal ‘M’,
   n is an integer defined by the relation 1≤n≤k; and
b. a particulate catalyst support, comprising particles having a volume based median particle diameter of at least 0.3 micrometer, preferably at least 1.0 micrometer, wherein the transition metal complex is supported on the particulate catalyst support;
   wherein further, an article prepared from the ultra-high molecular weight polyethylene is a drawn article characterized in that the breaking tenacity of the drawn article is related to the total draw ratio (DR) used for preparing the drawn article in accordance with equation (I):

BT>α*ln(DR)−β (Eqn I)

wherein the total draw ratio (DR) is at least 50.0, and the breaking tenacity (BT) is expressed in N/tex and 0.835≤α≤0.881 and 1.787≤β≤1.887 and the ratio of α/β is 0.467.

In certain embodiments, the articles may for example be fibres, films, tapes or yarns.

### EXAMPLES

Specific examples demonstrating some of the embodiments of the invention are included below. The examples are for illustrative purposes only and are not intended to limit the invention.

### Example 1 (Inventive)

Purpose: To evaluate the performance of UHMWPE polymer produced by polymerizing ethylene in the absence of hydrogen using particulate methyl-aluminoxane (MAO) supported bis-phenoxy-imine titanium complex [3-tBu-2-O—C₆H₃CH═N(C₆F₅)]₂TiCl₂, (abbreviated as Fl).

Catalyst system used: For the purpose of Example 1

TABLE 1
Catalyst system

| | Component | Supplier |
|---|---|---|
| Discrete | bis-phenoxy-imine titanium complex: | MCAT |
| transition | [3-tBu-2-O—C₆H₃CH═N(C₆F₅)]₂TiCl₂ | GmbH |
| metal | | |
| complex (FI | | |
| Compound) | | |
| Support | Morphology controlled solid particulate | Tosoh |
| | methyl-aluminoxane (MAO) as a suspension | Fine Chem |
| | in toluene. The suspension contained 13.9 | Corporation |
| | wt % solids. The aluminium content in the | |
| | solids was 38.8 wt %. | |
| Particle size | 5.5 micrometers | |
| of support | | |
| Scavenger | Tri-isobutylaluminium | Lanxess |

Catalyst preparation and Polymerization step: A series of ethylene polymerizations was performed, using the Fl compound as the discrete transition-metal complex supported on particulate methyl-aluminoxane (sMAO) as the particulate support, with tri-isobutyl aluminum as scavenger. The polymerizations steps were carried out in a 10 litre stirred autoclave using 5 litres of purified hexanes as a diluent. Tri-isobutylaluminium (1 mmol) as a scavenger was added to the 5 litre purified hexanes and the stirrer was set to 1000 RPM. The mixture was heated to the desired polymerization temperature (Tₚₒₗ) and pressurized with ethylene to the desired pressure. The total reactor pressure was calculated as the sum of the partial pressure of ethylene (P_{C2}) and hexanes.

In a separate glass vessel, under inert atmosphere, a solution containing a predetermined amount of the discrete transition metal complex (Fl compound) was premixed with a suspension containing a predetermined amount of particulate support (sMAO). Mixing was performed by shaking the resulting suspension manually. Typically, the premixing time was less than 10 minutes. Subsequently, the resulting suspension containing the supported catalyst was injected to the reactor via a pressurized sluice and the sluice was rinsed with hexanes. The temperature was maintained at the desired set-point via a water-cooled thermostat, and the pressure was kept constant by feeding ethylene through a mass flow meter. The mass flow meter indicated the differential and cumulative ethylene uptake (dosed C₂) by the polymerization reaction. The reaction was stopped when the desired amount of ethylene had been supplied to the reactor. Stopping of the reaction was performed by de-pressurizing and cooling down the reactor and decreasing the stirrer speed. The reactor contents were subsequently passed through a filter; the wet polymer powder was thereafter collected, subsequently dried at 50° C. in vacuo, weighed and analyzed. The polymerization conditions were varied in terms of pressure, dosed C₂ and the molar ratio of the aluminium from the sMAO to the Fl compound to obtain several samples each represented by a sample identification code. The corresponding polymer powder samples were identified on the basis of a sample number as provided below.

The polymerization conditions that was practiced is summarized as follows:

TABLE 2
Polymerization condition

| | Catalyst | | Pressure | Temperature of | Dosed | Polymerization |
|---|---|---|---|---|---|---|
| | (FI) conc | sMAO/FI | C2 | Polymerization | C₂ | time |
| Experiment No. | mmol/L | mol/mol | Bar | ° C. | gram | min |
| 20190904AKO2 | 0.02 | 400 | 1.5 | 30 | 104 | 18 |
| 20190905AKO1 | 0.02 | 400 | 1.5 | 30 | 200 | 48 |
| 20190905AKO2 | 0.02 | 400 | 1.5 | 30 | 402 | 115 |
| 20190906AKO1 | 0.02 | 400 | 1.5 | 30 | 800 | 289 |
| 20190909AKO3 | 0.04 | 200 | 1.5 | 30 | 205 | 19 |
| 20190910AKO1 | 0.04 | 200 | 1 | 30 | 802 | 105 |
| 20190910AKO2 | 0.02 | 200 | 1 | 30 | 200 | 56 |
| 20190911AKO1 | 0.02 | 200 | 1.5 | 30 | 800 | 275 |
| 20190923AKO2 | 0.06 | 133 | 1 | 30 | 750 | 293 |
| 20190925AKO1 | 0.02 | 400 | 1 | 30 | 251 | 48 |
| 20190925AKO2 | 0.01 | 800 | 1 | 30 | 250 | 127 |
| 20190926AKO1 | 0.08 | 100 | 1 | 30 | 1000 | 163 |
| 20190926AKO2 | 0.08 | 74 | 1 | 30 | 502 | 92 |
| 20190927AKO1 | 0.04 | 200 | 1 | 30 | 500 | 71 |
| 20190927AKO2 | 0.02 | 400 | 1 | 30 | 500 | 207 |
| 20191001AKO1 | 0.08 | 100 | 1 | 30 | 1001 | 163 |
| 20191001AKO2 | 0.08 | 74 | 1 | 30 | 500 | 92 |
| 20191017AKO1 | 0.01 | 400 | 1.5 | 60 | 100 | 37 |
| 20191111AKO2 | 0.025 | 320 | 3 | 30 | 302 | 25 |
| 20191112AKO1 | 0.025 | 320 | 1.5 | 30 | 300 | 40 |
| 20191112AKO2 | 0.025 | 320 | 2 | 30 | 300 | 30 |
| 20191113AKO1 | 0.025 | 320 | 1 | 60 | 300 | 91 |
| 20191113AKO2 | 0.02 | 320 | 3 | 60 | 241 | 24 |
| 20191114AKO1 | 0.02 | 320 | 1.5 | 60 | 240 | 69 |
| 20191115AKO1 | 0.02 | 320 | 2 | 60 | 240 | 33 |
| 20191115AKO2 | 0.015 | 320 | 3 | 30 | 183 | 28 |
| 20191126AKO3 | 0.025 | 320 | 1 | 30 | 300 | 140 |

Polymer Evaluation: The polymer samples obtained were evaluated for their properties with relation to powder bulk density, intrinsic viscosity, crystallinity, melting temperature and maximum draw ratio at specific draw ratios of 125° C. and 135° C.

Powder Bulk Density: The powder bulk density of the UHMWPE polymer powder obtained post polymerization was measured in accordance with the procedure prescribed under the standard ASTM D1895/A. The procedure involved filling a calibrated 100 mL steel cylinder with the polymer powder and thereafter measuring the weight of the cylinder having a calibrated polymer volume of 100 mL. In the event the polymer powder did not flow spontaneously, the procedure was adjusted by piercing the powder with a spatula to promote flow through the opening of a dosing vessel mounted above the 100 mL calibrated steel vessel.

Intrinsic Viscosity (IV): Intrinsic viscosity measurements of dilute solutions of the UHMWPE polymer was carried out as described in the standard ASTM D4020, involving a dilute solution of UHMWPE polymer in decalin at a temperature of 135° C.

Crystallinity (Xc) & melting temperature of polymer (Tₘ) were determined using Differential Scanning calorimetry (DSC): To minimize the thermal lag caused by the samples, a weight was kept within 1.5±0.2 mg for each sample. During the measurement, nitrogen was continuously purged at 50 mL/min to prevent sample degradation. The thermal protocol applied during the measurements involved: 1) first heating run at 10° C./min from −40° C. to 180° C., 2) an annealing step of 5 mins to erase the thermal history of the powder at 180 ° C. for 5 minutes, 3) a cooling run at 10° C./min from 180° C. to −40° C., and 4) a final heating run from −40° C. to 180 ° C.

Crystalline volume fraction (Xc) was evaluated from the melting endotherm obtained in 1), by using the ratio between the enthalpy measured during the heating runs and the equilibrium melting enthalpy for polyethylene (293 J/gr). The melting temperature (Tₘ) was taken at the maximum of the melting endotherm obtained in step 1) of this protocol.

Preparing tapes using high Draw Ratios: The polymer powder so obtained was converted first to a film specimen and subsequently to tapes following the procedure steps of (i) compacting the ultra-high molecular weight polyethylene polymer powder to a film specimen, (ii) rolling and/or calendaring the film specimen to form a rolled film specimen, and (iii) subsequently drawing the rolled film specimen to a tape.

Compaction: Nascent powders were first compacted into film specimens at 125° C. (i.e. below the melting point) and at a pressure of 200 bar.

Rolling/calendaring: The film specimens were then pre-drawn to about 3-4 times their initial length (L₂/L₁ is 3-4) in two separate steps by using calendar rolls at a temperature of 120° C. to improve film coherency and obtaining a rolled film specimen.

Solid state drawing: The rolled film specimen obtained after rolling/calendaring were drawn in solid state at a suitable draw ratio (L₃/L₂) to form a tape using a tensile instrument where the total drawing ratio was maintained greater than 50 (L₃/L₁).

Protocol for solid state drawing to determine maximum total draw ratio (λₘₐₓ): Dog-bone shaped tensile bar specimens (width 5 mm and grip-to-grip length 10.5 mm) were cut from the tapes obtained by using a bent-lever cutting press with a special punch. A Zwick Z010 universal tensile tester equipped with pneumatic clamps, 1 kN load cell, and thermostatically controlled temperature chamber, was used to perform solid-state drawing experiments at a constant initial strain rate of 0.1 s-1.Drawing experiments were conducted up to sample breakage or to the maximum total draw ratio (λₘₐₓ) at two different drawing temperatures, both below the melting point of the UHMWPE polymer consolidated tapes: 125° C. and 135° C. The value of (λₘₐₓ) represents a property of the polymer and is used to assess the extent of polymer entanglement.

The results obtained from the analysis is provided under Table 3 as shown:

TABLE 3
Polymer evaluation

| | | | | | | Intrinsic |
|---|---|---|---|---|---|---|
| | | | λₘₐₓ | λₘₐₓ | Bulk | Viscosity |
| | Xc DSC | Tₘ | 125° C. | 135° C. | Density | (IV) |
| Sample Code No. | % wt | ° C. | [mm/mm] | [mm/mm] | g/100 ml | dl/g |
| 20190904AKO2 | 82 | 140.8 | 189 ± 2 | 225 ± 5 | n.a. | 24.8 |
| 20190905AKO1 | 79 | 141.3 | 123 ± 3 | 165 ± 10 | 21.9 | 36.4 |
| 20190905AKO2 | 81 | 141.6 | 80 ± 4 | 106 ± 3 | 26.5 | 42.1 |
| 20190909AKO3 | 80 | 140.8 | >90 | >90 | n.a. | n.a. |
| 20190910AKO1 | 81 | 141.1 | 78 ± 3 | >90 | n.a. | 27.5 |
| 20190910AKO2 | 80 | 141.3 | >90 | | n.a. | 30.15 |
| 20190911AKO1 | 80 | 141.4 | 32 ± 7 | 53 ± 2 | n.a. | n.a. |
| 20190923AKO2 | 75 | 141.7 | 76 ± 10 | 171 ± 30 | 35 | 20.5 |
| 20190925AKO1 | 74 | 141.7 | >90 | 199 ± 43 | 23.4 | 29.25 |
| 20190925AKO2 | 73 | 141.6 | 63 ± 2 | >90 | 23.6 | 44.05 |
| 20190926AKO1 | 78 | 141.7 | 80 ± 3 | 128 ± 15 | 35.1 | 44.3 |
| 20190926AKO2 | 75 | 141.5 | 69 ± 6 | >90 | 31.3 | 41 |
| 20190927AKO1 | 75 | 140.6 | >90 | >90 | 23.9 | 32.6 |
| 20190927AKO2 | 75 | 141.5 | 74 ± 3 | >90 | n.a. | 23.5 |
| 20191001AKO1 | 74 | 141.7 | 79 ± 1 | >90 | 34.9 | 41.95 |
| 20191001AKO2 | 75 | 142 | >90 | >90 | 27.4 | 36.6 |
| 20191017AKO1 | 80 | 142.8 | 76 ± 8 | >90 | n.a. | 35.05 |
| 20191111AKO2 | 76 | 141.5 | 69 ± 4 | 79 ± 10 | n.a. | 34.95 |
| 20191112AKO1 | 76 | 141.3 | 72 ± 5 | >90 | n.a. | 27.15 |
| 20191112AKO2 | 79 | 141.2 | 84 ± 5 | >90 | n.a. | 24.75 |
| 20191113AKO1 | 78 | 143.0 | 63 ± 2 | 75 ± 5 | n.a. | 25.95 |
| 20191113AKO2 | 76 | 142.8 | 50 ± 1 | 65 ± 2 | n.a. | 27.2 |
| 20191114AKO1 | 78 | 143.0 | 54 ± 4 | 70 ± 4 | n.a. | 37.4 |
| 20191115AKO1 | 77 | 142.4 | 56 ± 2 | 66 ± 3 | n.a. | 21.25 |
| 20191115AKO2 | 78 | 141.3 | 70 ± 5 | 74 ± 6 | n.a. | 29.35 |
| 20191126AKO3 | 72 | 142.2 | 60 ± 4 | 80 ± 1 | n.a. | 42.85 |

From the results shown under Table 3, it is evident that the tape specimen samples prepared from the UHMWPE polymer could be drawn at a total draw ratio above 50 and in certain instances above 90, at drawing temperatures lower than 15° C. below the melting temperature of the polymer (λₘₐₓ 125° C.) without the requirement of a solvent to dissolve the polymer. The powder bulk density of the UHMWPE polymers obtained from the polymerization is high (above 20 gram/100 ml or 200 kg/m³), which in certain instances is higher than 350 kg/m³ (35.1 g/100 ml as reported for Sample No. 20190926AK01). During the polymerization process for preparing the UHMWPE polymers, reactor fouling was not observed. Further, it was observed that the polymer samples produced from the practice of Example 1, has an excellent balance of high crystallinity (>70%), desired bulk density and suitable drawability.

Protocol for tape testing: For the purpose of tape testing, tape specimens with Sample Code No. 20190925AKO1, 20190904AKO2, 20190905AKO1, 20190905AKO2, 20190923AKO2, 20190926AKO1 prepared as describe earlier, were evaluated by drawing at draw ratios lower than (λₘₐₓ). The uni-axially drawn tapes drawn at different draw ratios were tested at room temperature (25° C.) using a Zwick Z010 universal tensile tester. Side action grip pneumatic clamps with flat jaw faces, were used to prevent slippage and breakage at the clamps. The tests were performed at a constant rate of extension (crosshead travel rate) 50 mm/min. The breaking tenacity (or tensile strength) and modulus (segment between 0.3 and 0.4 N/tex) were determined from the force against displacement between the jaws. The tapes that broke at the clamps were discarded.

The tape width and thickness was determined by direct measurement using an optical microscope after image calibration with a micron-sized grid. The total draw ratio of the tapes were calculated by the ratio of the cross section of the tape specimen after drawing to that prior to drawing. Values of modulus and tenacity were obtained in GPa (10⁶N/m2) and subsequently converted to N/tex by dividing with the density of crystalline PE (0.98 kg/m³). The results obtained are tabulated under Table 4:

TABLE 4
Tape evaluation

| | | | | | |
|---|---|---|---|---|---|
| | Melting | | | | |
| | Temper- | Drawing | Total | | Tensile |
| | ature | temper- | Draw | Breaking | mod- |
| Sample | Tₘ | ature | Ratio | tenacity | ulus |
| Code No. | ° C. | ° C. | mm/mm | N/tex | N/tex |

20190925AKO1

| | | | | | |
|---|---|---|---|---|---|
| 20190925AKO1 | 141.7 | 135 | 58 | 2.43 | 114.01 |
| 20190925AKO1 | 141.7 | 135 | 62 | 2.02 | 99.81 |
| 20190925AKO1 | 141.7 | 135 | 63 | 2.12 | 106.63 |
| 20190925AKO1 | 141.7 | 135 | 66 | 2.16 | 122.53 |
| 20190925AKO1 | 141.7 | 135 | 66 | 2.03 | 127.29 |
| 20190925AKO1 | 141.7 | 135 | 69 | 2.22 | 112.67 |
| 20190925AKO1 | 141.7 | 135 | 69 | 2.71 | 123.55 |
| 20190925AKO1 | 141.7 | 135 | 70 | 2.15 | 144.29 |
| 20190925AKO1 | 141.7 | 135 | 85 | 2.39 | 145.94 |
| 20190925AKO1 | 141.7 | 135 | 92 | 2.36 | 154.45 |
| 20190925AKO1 | 141.7 | 135 | 94 | 2.32 | 142.76 |
| 20190925AKO1 | 141.7 | 135 | 102 | 2.66 | 149.92 |
| 20190925AKO1 | 141.7 | 135 | 102 | 2.49 | 170.73 |
| 20190925AKO1 | 141.7 | 135 | 146.5 | 2.70 | 125.26 |
| 20190925AKO1 | 141.7 | 135 | 169.5 | 3.27 | 170.53 |
| 20190925AKO1 | 141.7 | 135 | 184.64 | 3.50 | 191.58 |
| 20190925AKO1 | 141.7 | 135 | 224.37 | 2.96 | 150.74 |
| 20190925AKO1 | 141.7 | 135 | 269.36 | 3.06 | 126.32 |

20190904AKO2

| | | | | | |
|---|---|---|---|---|---|
| 20190904AKO2 | 140.8 | 120 | 188 | 3.27 | 151.58 |
| 20190904AKO2 | 140.8 | 120 | 191 | 3.71 | 144.21 |
| 20190904AKO2 | 140.8 | 130 | 220 | 3.47 | 147.37 |
| 20190904AKO2 | 140.8 | 130 | 230 | 3.27 | 181.05 |

20190905AKO1

| | | | | | |
|---|---|---|---|---|---|
| 20190905AKO1 | 141.3 | 130 | 120 | 2.47 | 151.58 |
| 20190905AKO1 | 141.3 | 130 | 172 | 2.68 | 168.42 |

20190905AKO2

| | | | | | |
|---|---|---|---|---|---|
| 20190905AKO2 | 141.6 | 130 | 106 | 2.58 | 137.89 |
| 20190905AKO2 | 141.6 | 130 | 106 | 2.44 | 132.63 |
| 20190905AKO2 | 141.6 | 135 | 120 | 2.80 | 147.37 |
| 20190905AKO2 | 141.6 | 135 | 120 | 2.70 | 126.32 |
| 20190905AKO2 | 141.6 | 135 | 120 | 2.54 | 152.63 |

20190923AKO2

| | | | | | |
|---|---|---|---|---|---|
| 20190923AKO2 | 141.7 | 135 | 127.4 | 2.96 | 170.53 |
| 20190923AKO2 | 141.7 | 135 | 128.3 | 2.86 | 188.42 |
| 20190923AKO2 | 141.7 | 135 | 164.9 | 2.89 | 174.95 |
| 20190923AKO2 | 141.7 | 135 | 202 | 3.88 | 209.47 |
| 20190923AKO2 | 141.7 | 135 | 233.9 | 3.67 | 209.47 |

20190926AKO1

| | | | | | |
|---|---|---|---|---|---|
| 20190926AKO1 | 141.7 | 135 | 106.4 | 3.01 | 123.16 |
| 20190926AKO1 | 141.7 | 135 | 114.7 | 2.95 | 133.05 |
| 20190926AKO1 | 141.7 | 135 | 124.6 | 3.11 | 159.79 |
| 20190926AKO1 | 141.7 | 135 | 129.3 | 3.10 | 176.84 |
| 20190926AKO1 | 141.7 | 135 | 142.3 | 3.15 | 152.74 |
| 20190926AKO1 | 141.7 | 135 | 148.3 | 3.08 | 175.79 |

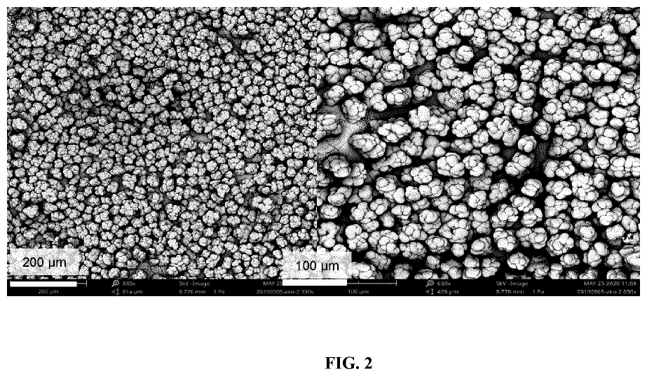

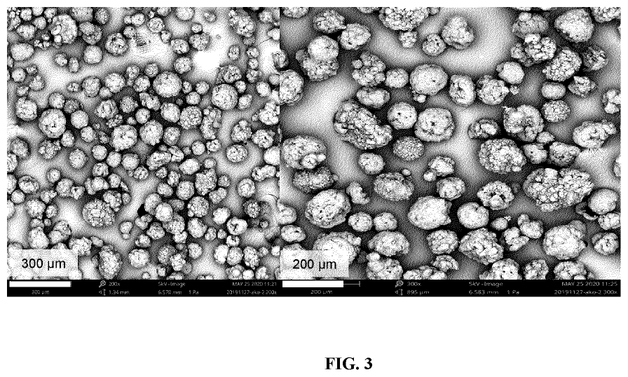

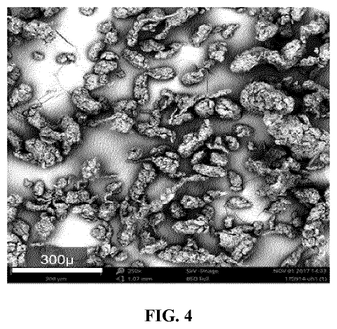

From the results of Example 1, it is evident that the inventive polymers are disentangled UHMWPE polymers, having bulk density comparable to low entangled UHMWPE polymers while imparting excellent breaking tenacity. The results provided under Table 4 indicate that the tapes prepared from the UHMWPE polymers of Example 1, can be drawn in solid state at high draw ratios (draw ratio>50.0) while retaining excellent mechanical property as denoted by the Breaking Tenacity and Tensile modulus values. In particular, the tapes/specimens obtained from the practice of Example 1 demonstrate high breaking tenacity even at high total draw ratio and satisfies the provision of Equation II. Further, the Scanning Electron Microscopy (SEM) images under FIG. 2 (a) indicates a well-defined powder shape and morphology as opposed to the polymer powder morphology obtained from the practice of comparative Example 3 (FIG. 3) and Example 4 (FIG. 4).

### Example 2 (Inventive)

Purpose: The purpose of Example 2 is identical to that of Example 1 except that the polymerization of ethylene was conducted in the presence of hydrogen as opposed to the process described in Example 1, where the polymerization of ethylene was conducted in the absence of hydrogen. The UHMWPE polymer and subsequently the tape obtained from the practice of Example 2 (Sample Code: 20191218AKO2) was compared with polymer and tape represented by Sample Code 20190925AKO2 of Example 1.

The catalyst used for the purpose of Example 2 was identical to that of Example 1. The polymerization parameters for Example 2 is provided below under Table 5:

TABLE 5
Polymerization condition

| | | FI | | | Temperature | | | Polymerization |
|---|---|---|---|---|---|---|---|---|
| Example | | conc. | sMAO/FI | Pressure_{c2} | Polymerization | Dosed C₂ | pH₂/pC₂ | Time |
| Reference | Sample Code No | mmol/L | mol/mol | bar | ° C. | gram | bar/bar | min |
| Example 2 | 20191218AKO2 | 0.015 | 320 | 1.5 | 30 | 280 | 0.00275 | 124 |
| Example 1 | 20190925AKO2 | 0.010 | 800 | 1 | 30 | 250 | 0 | 127 |

The polymer analysis is given below under Table 6:

TABLE 6
Polymer evaluation

| | | Xc | | λₘₐₓ | λₘₐₓ | |
|---|---|---|---|---|---|---|
| Example | | DSC | Tₘ | 125° C. | 135° C. | I.V |
| Reference | Sample Code No | % wt | ° C. | [mm/mm] | [mm/mm] | dl/g |
| Example 2 | 20191218AKO2 | 77 | 141.2 | 74 ± 6 | >90 | 25.2 |
| Example 1 | 20190925AKO2 | 73 | 141.6 | 63 ± 2 | >90 | 44.0 |

From these experiments it is clear that hydrogen reduces the molecular weight of the polymer significantly as indicated by the reduction of intrinsic viscosity (I.V). Further, the bulk density for the polymer so obtained is comparable to that obtained under Example 1.

From the polymer sample obtained from the practice of Example 2, (Sample Code 20191218AKO2) several tapes were prepared, drawn at various total draw ratios (DR) below the maximum total draw ratio (λₘₐₓ) and subsequently evaluated for its mechanical strength (breaking tenacity and tensile modulus).

TABLE 7
Tape evaluation

| | | Drawing | Total | | |
|---|---|---|---|---|---|
| | | temper- | Draw | Breaking | Tensile |
| | Tₘ | ature | ratio | tenacity | modulus |
| Sample No: | ° C. | ° C. | mm/mm | N/tex | N/tex |
| 20191218AKO2 | 141.2 | 135 | 60 | 2.20 | 111.76 |
| 20191218AKO2 | 141.2 | 135 | 64 | 2.46 | 133.56 |
| 20191218AKO2 | 141.2 | 135 | 67 | 2.27 | 112.83 |

From the data as provided under Table 7, it is evident that the tapes can be prepared using solid state drawing resulting in excellent breaking tenacity and tensile modulus properties.

### Example 3 (Comparative)

Purpose: The purpose of Example 3 is to compare the performance of a silica supported catalyst in the production of UHMWPE polymer and tapes made from such polymers.

Catalyst system used: For the purpose of Example 3 an Fl catalyst system supported on particulate silica support was used instead of particulate MAO support:

TABLE 8
Catalyst system

| | Component | Supplier |
|---|---|---|
| Catalyst | bis-phenoxy-imine titanium complex [3- | MCAT |
| component | tBu-2-O—C₆H₃CH═N(C₆F₅)]₂TiCl₂ | GmbH |
| (FI) | | |
| Support | ES757 silica, with an average particle | Ineos |
| | size of 27 microns, was dried at 600° C. | |
| | for 4 hours. | |
| Scavenger | Tri-isobutylaluminium | |
| Co-Catalyst | Soluble methyl-aluminoxane (MAO) | Lanxess |
| Activator | 10 wt % solution in toluene. | |

Catalyst preparation, involved the premixing of the discrete transition-metal complex (Fl compound), with a solution of methyl-aluminoxane (MAO) in toluene. Subsequently, the catalyst premix was brought in contact with the particulate ES757 silica support. The molar ratio of aluminium in the activator to the active catalyst component (MAO/Fl molar ratio) was maintained at 200. Three grams of the supported Fl catalyst system was used per polymerization-experiment.

The polymerization conditions are as provided in Table 9:

TABLE 9
Polymerization condition

| | | Pres- | Temperature | | Polymer- |
|---|---|---|---|---|---|
| | | sure | of Polymer- | Dosed | ization. |
| Sample | | C₂ | ization | C₂ | Time |
| Code No: | MAO/FI | bar | ° C. | gram | min |
| 20191018AKO2 | 200 | 3.5 | 30 | 250 | 75 |
| 20191127AKO2 | 200 | 1.5 | 30 | 120 | 75 |

The UHMWPE polymer obtained was evaluated and the results are provided below:

TABLE 10
Polymer evaluation

| | | | | | Intrinsic |
|---|---|---|---|---|---|
| | | | λmax | | Viscosity |
| Sample | Xc | Tₘ | 125° C. | Bulk Density | (IV) |
| Code No: | % wt | ° C. | [mm/mm] | g/100 ml | dl/g |
| 20191018AKO2 | 72 | 142.8 | 27 ± 3 | 29.4 | 56 |
| 20191127AKO2 | 70 | 142.9 | 44 ± 1 | n.a. | 40.7 |

There was no reactor fouling observed while bulk density of the polymer powder obtained was acceptable. However, the maximum draw ratio at drawing temperature of 125° C. (λₘₐₓ 125° C.) was observed to be below 50 which is less than desirable as the desired strength and modulus of the produced tape will not be achieved. Subsequently, tapes were made and drawn at various draw ratios below λmax and the strength of the tapes so obtained were evaluated:

TABLE 11
Tape evaluation

| | | Drawing | Total | | |
|---|---|---|---|---|---|
| | | temper- | Draw | Breaking | Tensile |
| | Tₘ | ature | ratio | tenacity | modulus |
| Sample Code: | ° C. | ° C. | mm/mm | N/tex | N/tex |
| 20191127AKO2 | 142.9 | 135 | 18 | 0.65 | 10.62 |
| 20191127AKO2 | 142.9 | 135 | 20 | 0.69 | 11.29 |
| 20191127AKO2 | 142.9 | 135 | 21 | 0.68 | 13.31 |
| 20191127AKO2 | 142.9 | 135 | 22 | 0.99 | 28.42 |
| 20191127AKO2 | 142.9 | 135 | 23 | 0.89 | 24.71 |
| 20191127AKO2 | 142.9 | 135 | 23 | 0.81 | 22.69 |
| 20191127AKO2 | 142.9 | 135 | 24 | 0.94 | 30.16 |
| 20191127AKO2 | 142.9 | 135 | 24 | 0.80 | 20.90 |
| 20191127AKO2 | 142.9 | 135 | 36 | 1.30 | 63.26 |
| 20191127AKO2 | 142.9 | 135 | 36 | 1.20 | 65.80 |
| 20191127AKO2 | 142.9 | 135 | 38 | 1.29 | 68.27 |
| 20191127AKO2 | 142.9 | 135 | 38 | 1.13 | 70.66 |
| 20191127AKO2 | 142.9 | 135 | 38 | 1.02 | 56.94 |
| 20191127AKO2 | 142.9 | 135 | 43 | 0.97 | 72.00 |
| 20191127AKO2 | 142.9 | 135 | 47 | 1.00 | 78.87 |
| 20191127AKO2 | 142.9 | 135 | 48 | 1.13 | 75.82 |

From Comparative Examples 3, it is evident that the tapes could not be drawn to the desired total draw ratios and the strength of the drawn specimen reached a maximum breaking tenacity of only 1.3 N/tex (20191127AKO2) which is lower than what was achieved for the tapes produced in the practice of Example 1 and Example 2. Further, unlike the inventive Example 1-2, the tapes prepared under Example 3 could be drawn in solid state at high total draw ratio only at few degrees (135° C.) below the melting temperature of the polymer. At drawing temperature of 125° C., the desired draw ratio was not achieved. Further, from FIG. 3, the powder morphology of the polymer obtained was not as well defined as that obtained from inventive Example 1.

### Example 4 (Comparative)

Purpose: The purpose of Example 4 is to evaluate the performance of an unsupported Fl catalyst compound for the production of UHMWPE polymer and tapes.

Catalyst system used: For the purpose of Example 4 an unsupported Fl catalyst system was used instead of a particulate support:

TABLE 12
Catalyst system

| | Component | Supplier |
|---|---|---|
| Catalyst | bis-phenoxy-imine titanium complex [3- | MCAT |
| component (FI) | tBu-2-O-C₆H₃CH═N(C₆F₅)]₂TiCl₂ | GmbH |
| Support | None | |
| Catalyst Activator | Soluble MAO 10 wt % solution in toluene. | Lanxess |

The polymerization condition and the polymer characteristics are provided under Table 13. For the purpose of Example 4, two samples were evaluated (i) Sample Code PDR-7309-6 and (ii) Sample Code ACE-170922-uh1. The polymerization conditions used and the polymer so obtained was evaluated and the results are provided under Table 13:

TABLE 13
Polymerization condition and Polymer evaluation

| | Fl | | Pressure | Polymerization | Dosed | Polymerization | λₘₐₓ | Bulk | |
|---|---|---|---|---|---|---|---|---|---|
| | conc. | MAO/FI | C₂ | Temperature | C₂ | Time | 125° C. | Density | IV |
| Sample code | μmol/L | mol/mol | bar | gr · C. | gram | min | [mm/mm] | g/100 ml | dl/g |
| PDR-7309-6 | 0.5 | 200 | 1 | 30 | 7.6 | 180 | >90 | ~10 | 35 |
| ACE-170922-uh1 | 11 | 225 | 1 | 30 | 100 | 12 | >90 | 8 | 22 |

Severe reactor-fouling was observed during the above polymerization process for both the samples, as was indicated by polymer deposits on the reactor walls and the stirrers. Further, as indicated by the low bulk density values of the polymer, the UHMWPE polymer obtained demonstrated poor morphology. From the polymer samples obtained, tapes were prepared at various total draw ratios. The results of the tape evaluation is provided below:

TABLE 14
Polymerization condition and Polymer evaluation

| | | | Total | | |
|---|---|---|---|---|---|
| | | Drawing | Draw | Breaking | Tensile |
| Sample | Tₘ | temperature | ratio | tenacity | modulus |
| Code No. | ° C. | ° C. | mm/mm | N/tex | N/tex |
| PDR-7309-6 | 142.9 | 135 | 35 | 1.70 | 65.82 |
| PDR-7309-6 | 142.9 | 135 | 30 | 1.73 | 57.57 |
| PDR-7309-6 | 142.9 | 135 | 37 | 1.99 | 74.77 |
| PDR-7309-6 | 142.9 | 135 | 37 | 2.04 | 84.70 |
| PDR-7309-6 | 142.9 | 135 | 17 | 2.30 | 86.20 |
| PDR-7309-6 | 142.9 | 135 | 69 | 2.57 | 135.73 |
| PDR-7309-6 | 142.9 | 135 | 67 | 2.58 | 143.48 |
| PDR-7309-6 | 142.9 | 135 | 71 | 2.71 | 143.86 |
| PDR-7309-6 | 142.9 | 135 | 62 | 2.78 | 141.29 |
| PDR-7309-6 | 142.9 | 135 | 109 | 2.94 | 196.75 |
| PDR-7309-6 | 142.9 | 135 | 102 | 2.98 | 166.78 |
| PDR-7309-6 | 142.9 | 135 | 100 | 3.29 | 192.23 |
| ACE-170922-uh1 | 142.1 | 135 | 200 | 4.56 | 161.12 |
| ACE-170922-uh1 | 142.1 | 135 | 93 | 2.88 | 80.65 |
| ACE-170922-uh1 | 142.1 | 135 | 74 | 2.21 | 75.46 |
| ACE-170922-uh1 | 142.1 | 135 | 153 | 4.13 | 140.93 |
| ACE-170922-uh1 | 142.1 | 135 | 186 | 4.11 | 150.68 |

Although the tapes made from the polymers demonstrated acceptable mechanical strength and modulus, owing to severe reactor fouling and the poor powder morphological properties, upscaling the production towards a commercial system would be difficult. As evidenced by the Scanning Electron Microscopy (SEM) images under FIG. 4, the polymer powder obtained indicated irregular powder shape and morphology.

Summary: A summary of the results obtained in terms of the key parameters from the practice of Example 1-4 is provided below under Table 15.

TABLE 15
Summary of the results from Examples 1-4

| | Solid State | | | |
|---|---|---|---|---|
| | drawing of | | Mechanical | |
| | UHMWPE | Powder | Strength of Tape | |
| | polymer 15° C. | Morphology | (Breaking | |
| | below Tₘ | of UHMWPE | Tenacity versus | Rector Fouling |
| | (λₘₐₓ 125° C./ | powder | Draw Ratio >50 as | During |
| Example | 135° C.) >50 | (Bulk Density) | expressed as Eqn II) | polymerization |
| Example 1 | Demonstrated | Good | Good | Not observed |
| Example 2 | Demonstrated | Good | Good | Not observed |
| Example 3 | Not Demonstrated | Good | Poor | Not observed |
| Example 4 | Demonstrated | Poor | Good | Severe |

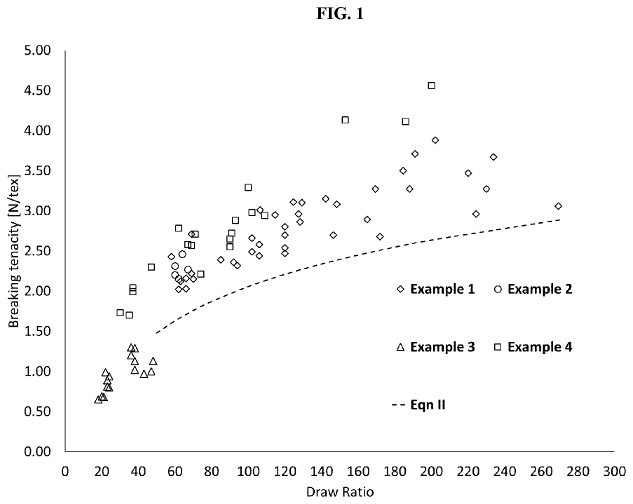

From the qualitative summary provided under Table 15, it is evident that the inventive Example 1 and 2 provide a balance of all desired properties while being produced without severe reactor fouling. Further FIG. 1, demonstrates that the inventive Examples 1-2 provides tapes which have high strength and modulus which can be drawn at high drawing ratios. Although, Example 4, provides tapes, which also have high strength (breaking tenacity) but the polymers have poor bulk density and the production of the polymers causes severe reactor fouling rendering the overall production of polymers under the process of Example 4 unfeasible at a commercial scale.

1. An ultra-high molecular weight polyethylene polymer having:
a powder bulk density of at least 200 kg/m³, as measured in accordance with ASTM D1895/A (1996, reapproved 2010-e1);
an intrinsic viscosity (I. V.) of at least 8.0 dl/g, as measured in accordance with ASTM D4020 (2005); and
wherein a specimen prepared from the ultra-high molecular weight polyethylene can be drawn in the absence of a solvent at a total draw ratio of at least 50.0, when drawing at a drawing temperature of ≥Tₘ−30° C., wherein Tₘ is the melting temperature of the ultra-high molecular weight polyethylene polymer.

2. The ultra-high molecular weight polyethylene polymer according to claim 1, wherein the ultra-high molecular weight polyethylene polymer is an ultra-high molecular weight polyethylene polymer powder having an average particle size (D₅₀) in the range of 50.0 and 250.0 micrometer as measured in accordance with ISO-13320 (2009).

3. The ultra-high molecular weight polyethylene polymer according to claims 1, wherein the ultra-high molecular weight polyethylene polymer is a copolymer comprising:
at least 95.0 wt. %, with regard to the total weight of the ultra-high molecular weight polyethylene polymer, of moieties derived from ethylene; and
at most 5.0 wt. %, with regard to the total weight of the ultra-high molecular weight polyethylene polymer, of moieties derived from one or more a-olefins selected from propylene, 1-butene, 4-methyl-1-pentene, 1-hexene, or 1-octene.

4. An article prepared from the ultra-high molecular weight polyethylene according to claim 1 having:
a powder bulk density of at least 200 kg/m³;
an intrinsic viscosity (I.V.) of at least 8.0 dl/g, as measured in accordance with ASTM D4020; and
wherein a specimen prepared from the ultra-high molecular weight polyethylene can be drawn in the absence of a solvent, at a total draw ratio of at least 50.0, when drawing at a drawing temperature of <Tₘ−30° C., wherein Tₘ is the melting temperature of the ultra-high molecular weight polyethylene polymer.

5. The article according to claim 4, wherein the article is a drawn article characterized in that the breaking tenacity of the drawn article is related to the total draw ratio (DR) used for preparing the drawn article in accordance with equation (I):
BT>α*ln(DR)−β (Eqn I)
wherein the total draw ratio (DR) is at least 50.0, and the breaking tenacity (BT) is expressed in N/tex and 0.835≤α≤0.881 and 1.787≤β≤1.887 and the ratio of α/β is 0.476.

6. A process for preparing the drawn article according to claim 5, comprising the step of:
compacting the ultra-high molecular weight polyethylene polymer powder into a film specimen having a length of L₁; and
rolling and/or calendaring the film specimen to a rolled film specimen having a length of L₂ at a drawing ratio represented by the ratio L₂/L₁≥2; and
drawing the rolled film specimen at a drawing temperature of ≥Tₘ−30° C., and forming the drawn article having a length of L₃, wherein Tₘ is the melting temperature of the ultra-high molecular weight polyethylene polymer and wherein the rolled film specimen is drawn at a drawing ratio represented by the ratio L₃/L₂, such that the total draw ratio L₃/L₁≥50.

7. The process according to claim 6, wherein:
the compaction is performed at a temperature of between Tₘ−30° C. and Tₘ, and/or at a pressure of >100 bar and <300 bar; and/or
the rolling is performed to a ratio L₂/L₁ of between 2 and 5, and/or at a temperature of between Tₘ−30° C. and Tₘ.

8. A catalyst composition for preparing the ultra-high molecular weight polyethylene polymer according to claim 1, comprising:
a. a transition metal complex represented by a formula (I) LₙMX₍ₖ₋ₙ₎, wherein
L represents an organic ligand,
M represents a transition metal,
X represents a substituent selected from fluorine, chlorine, bromine or iodine, an alkyl group having 1-20 carbon atoms, an aralkyl group having 1-20 carbon atoms, a dialkylamine group having 1-20 carbon atoms or an alkoxy group having 1-20 carbon atoms,
k represents a positive integer and is the valency of the transition metal ‘M’,
n is an integer defined by the relation 1≤n≤k; and
b. a particulate catalyst support, comprising particles having a volume based median particle diameter of at least 0.3 micrometer, wherein the transition metal complex is supported on the particulate catalyst support.

9. The catalyst composition according to claim 8, wherein the particulate catalyst support comprises particulate organo-aluminium selected from methyl-aluminoxane (MAO), iso-butyl-aluminoxane, methyl-isobutyl aluminoxane, or ethyl-isobutyl-aluminoxane.

10. The catalyst composition according to claim 8, wherein the organic ligand (L) is selected from substituted or unsubstituted cyclopentadienyl, indenyl, fluorenyl, naphthyl, phenoxy, imine, amine, pyridyl, phenoxy-imine, phenoxy-amine, phenoxy-ether, quinolyl-indenyl, phenoxy-ether, benzyl, neophyl, neopentyl, or a combination thereof.

11. The catalyst composition according to claim 8, wherein the transition metal (M) is a metal selected from group IV of Mendelejev's Periodic Table of Elements.

12. The catalyst composition according to claim 8, wherein the catalyst composition comprises bis-phenoxy-imine titanium dichloride supported on particulate methyl-aluminoxane (MAO) particles having a volume based median particle diameter of at least 0.3 micrometer.

13. The catalyst composition according to claim 8, wherein the catalyst composition further comprises a scavenger additive selected from an organolithium compound, an organo-magnesium compound, an organo-aluminum compound, an organo-zinc compound, or mixtures thereof.

14. A process for preparing the ultra-high molecular weight polyethylene polymer according to claim 1 comprising the step of polymerizing ethylene and optionally one or more a-olefins in the presence of thea catalyst composition and optionally in presence of hydrogen,
wherein the catalyst composition comprises:
a. a transition metal complex represented by a formula (I) LₙMX₍ₖ₋ₙ₎, wherein
L represents an organic ligand,
M represents a transition metal,
X represents a substituent selected from fluorine, chlorine, bromine or iodine, an alkyl group having 1-20 carbon atoms, an aralkyl group having 1-20 carbon atoms, a dialkylamine group having 1-20 carbon atoms or an alkoxy group having 1-20 carbon atoms,
k represents a positive integer and is the valency of the transition metal ‘M’,
n is an integer defined by the relation 1≤n≤k; and
b. a particulate catalyst support, comprising particles having a volume based median particle diameter of at least 0.3 micrometer, wherein the transition metal complex is supported on the particulate catalyst support.

15. The process according to claim 14, wherein the organic ligand (L) is selected from phenoxy-imine, phenoxy-amine, or phenoxy-ether.
